(19) United States
(12) Patent Application Publication
(10) Pub. No.: US 2024/0217385 A1
(43) Pub. Date: Jul. 4, 2024

(54) OPERATION MANAGEMENT SYSTEM, OPERATION MANAGEMENT METHOD, AND OPERATION MANAGEMENT PROGRAM

(71) Applicant: Energywith Co., Ltd., Tokyo (JP)

(72) Inventors: Koji HAYATA, Tokyo (JP); Akihiko KUDO, Tokyo (JP); Hideharu OOMIZU, Tokyo (JP)

(21) Appl. No.: 18/563,199

(22) PCT Filed: May 25, 2022
(86) PCT No.: PCT/JP2022/021437

§ 371 Date: Nov. 21, 2023

(30) Foreign Application Priority Data
May 28, 2021 (JP) 2021-090527

(51) Int. Cl. B60L 58/10

(52) U.S. Cl. CPC B60L 58/10

(57) ABSTRACT

An operation management system according to an example includes an acquisition unit configured to acquire rechargeable battery data indicating a state of a rechargeable battery mounted on an electric vehicle; an estimation unit configured to estimate an actual operating state of the electric vehicle based on the rechargeable battery data; a generation unit configured to generate a report indicating operation information that is based on the actual operating state; and an output unit configured to output the report.

### TECHNICAL FIELD

An aspect of the present disclosure relates to an operation management system, an operation management method, and an operation management program.

### BACKGROUND ART

Patent Literature 1 describes a state monitoring system for a lead-acid battery. This system includes a device for measuring an internal resistance of the lead-acid battery, a device for calculating an average of the internal resistance for each predetermined period, comparing the average of the internal resistance for each predetermined period with an average for an immediately preceding predetermined period, and calculating a change rate between the average values, and a device for alarming or displaying a replacement timing of the lead-acid battery in a case where the change rate exceeds a prescribed value.

### CITATION LIST

### Patent Literature

[Patent Literature 1] JP 4353653 B

### SUMMARY OF INVENTION

### Technical Problem

It is desired to convey information about actual operation of an electric vehicle to a user.

### Solution to Problem

An operation management system according to an aspect of the present disclosure includes: an acquisition unit configured to acquire rechargeable battery data indicating a state of a rechargeable battery mounted on an electric vehicle; an estimation unit configured to estimate an actual operating state of the electric vehicle based on the rechargeable battery data; a generation unit configured to generate a report indicating operation information that is based on the actual operating state; and an output unit configured to output the report.

An operation management method according to an aspect of the present disclosure is executed by an operation management system including at least one processor. The operation management method includes: acquiring rechargeable battery data indicating a state of a rechargeable battery mounted on an electric vehicle; estimating an actual operating state of the electric vehicle based on the rechargeable battery data; generating a report indicating operation information that is based on the actual operating state; and outputting the report.

An operation management program according to an aspect of the present disclosure causes a computer to execute: acquiring rechargeable battery data indicating a state of a rechargeable battery mounted on an electric vehicle; estimating an actual operating state of the electric vehicle based on the rechargeable battery data; generating a report indicating operation information that is based on the actual operating state; and outputting the report.

In such aspects, the actual operating state of the electric vehicle is estimated from rechargeable battery data related to the rechargeable battery mounted on the electric vehicle. Then, the report indicating the operation information based on the actual operating state is generated. This report makes it possible to convey information about actual operation of the electric vehicle to a user.

### Advantageous Effects of Invention

According to an aspect of the present disclosure, it is possible to convey information about actual operation of an electric vehicle to a user.

### BRIEF DESCRIPTION OF DRAWINGS

FIG. 1 is a diagram showing an example functional configuration of an operation management system according to an embodiment.

FIG. 2 is a diagram showing an example hardware configuration of a computer constituting the operation management system according to the embodiment.

FIG. 3 is a flowchart showing an example of processing executed by the operation management system according to the embodiment.

FIG. 4 is a graph showing an example of a temporal change of moving average of measured current.

FIG. 5 is a diagram showing examples of report.

FIG. 6 is a diagram showing another example of report.

### DESCRIPTION OF EMBODIMENTS

Hereinafter, embodiments of the present disclosure will be described in detail with reference to the accompanying drawings. In the description of the drawings, the same or equivalent elements are denoted by the same reference signs, and redundant description is omitted.

### [Configuration of System]

An operation management system 1 according to an embodiment is a computer system that estimates an actual operating state of an electric vehicle and provides a use with a report that is based on an estimation result. The electric vehicle refers to a vehicle that travels using electrical energy stored in a rechargeable battery (secondary battery) as all or part of power. The electric vehicle may be a vehicle for carrying a person or a vehicle for moving a cargo. The electric vehicle may be a material handling vehicle for moving cargos, for example a forklift. Examples of types of rechargeable battery include, but are not limited to, a lead-acid battery and a lithium-ion battery. The rechargeable battery may be an assembled battery composed of a plurality of single batteries of the same type. The “actual operating state of the electric vehicle” is information indicating how long the electric vehicle has actually operated in a time width in which the electric vehicle is to be operated. In one example, the operation management system 1 may provide the user with a report based on the actual operating state of the material handling vehicle carrying the lead-acid battery.

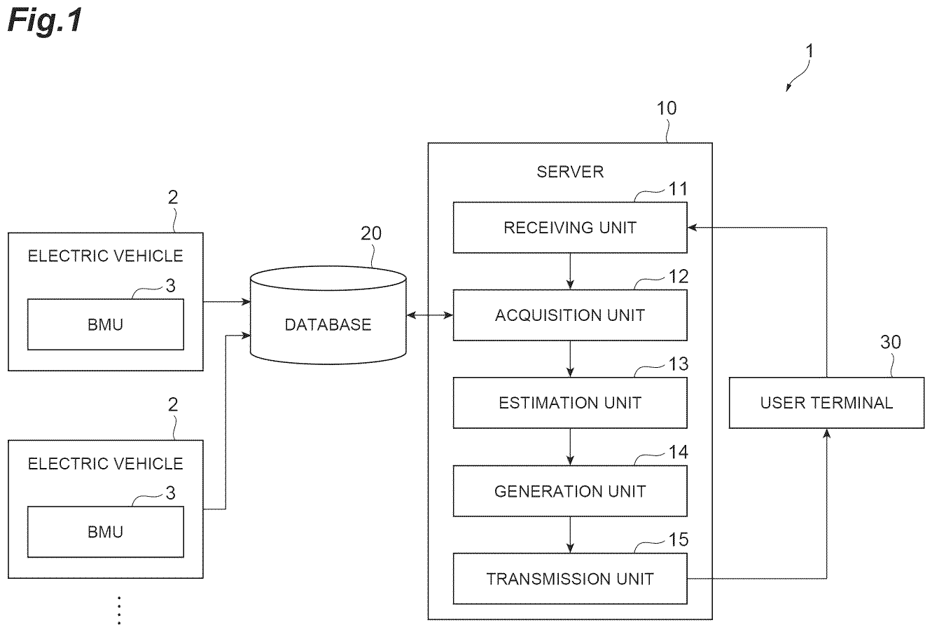

FIG. 1 is a diagram showing an example functional configuration of the operation management system 1. In one example, the operation management system 1 includes a server 10. The server 10 may access, via a communication network, a database 20 that stores rechargeable battery data indicating a status of the rechargeable battery mounted on the electric vehicle 2. The database 20 stores the rechargeable battery data for each of the at least one electric vehicle 2. The database 20 may be a component of the operation management system 1 or may be provided in a computer system separate from the operation management system 1. The server 10 is further connected to at least one user terminal 30 via a communication network. The communication network used for the operation management system 1 is constituted by, for example, at least one of the Internet and an intranet.

The individual electric vehicle 2 provides the rechargeable battery data to the database 20. The electric vehicle 2 includes a battery management unit (BMU) 3 that monitors or controls the rechargeable battery. The BMU 3 repeatedly measures the state of the rechargeable battery at given time intervals and generates the rechargeable battery data indicative of that state. The BMU 3 then transmits the rechargeable battery data to the database 20 via the communication network at a given timing. The rechargeable battery data is time-series data indicating the state of the rechargeable battery. For example, each record of the rechargeable battery data includes a measurement date and time and at least one physical quantity indicating the state of the rechargeable battery. Examples of the physical quantity include, but are not limited to, a measured voltage, a measured current, and a measured temperature. The rechargeable battery data indicates physical quantities measured every 100 milliseconds, for example. In the database 20, the rechargeable battery data is associated with at least one of a rechargeable battery ID and an electric vehicle ID. The rechargeable battery ID is an identifier that uniquely identifies a rechargeable battery. The electric vehicle ID is an identifier that uniquely identifies the electric vehicle 2.

The server 10 is a computer that estimates an actual operating state of an electric vehicle based on rechargeable battery data and provides a user with a report that is based on the actual operating state. The server 10 includes a receiving unit 11, an acquisition unit 12, an estimation unit 13, a generation unit 14, and a transmission unit 15 as functional modules. The receiving unit 11 is a functional module that receives, from the user terminal 30, a request to generate and provide the report. The acquisition unit 12 is a functional module that acquires the rechargeable battery data from the database 20 based on the request. The estimation unit 13 is a functional module that estimates the actual operating state of the electric vehicle based on the rechargeable battery data. The generation unit 14 is a functional module that generates the report indicating operation information based on the actual operating state. The transmission unit 15 is a functional module that transmits the report to the user terminal 30. The transmission is an example of the output of the report, and thus the transmission unit 15 functions as an output unit.

The user terminal 30 is a computer operated by a user of the operation management system 1. Examples of users include, but are not limited to, an owner or administrator of the electric vehicle 2.

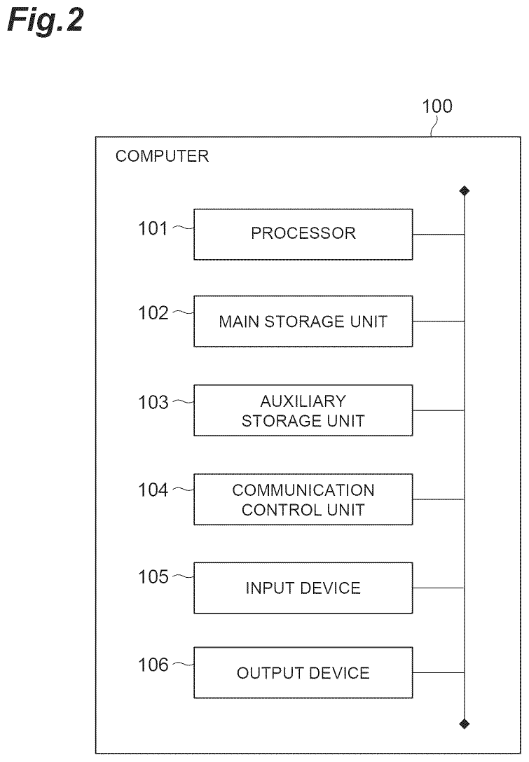

FIG. 2 is a diagram showing an example of a general hardware configuration of a computer 100 constituting the server 10. For example, the computer 100 includes a processor (for example, a CPU) 101 that executes an operating system, an application program, and the like, a main storage unit 102 constituted by a ROM and a RAM, an auxiliary storage unit 103 constituted by a storage device such as a hard disk or a flash memory, a communication control unit 104 constituted by a network card or a wireless communication module, an input device 105 such as a keyboard or a mouse, and an output device 106 such as a monitor.

Each functional module of the server 10 is implemented by reading a predetermined program on a processor 101 or the main storage unit 102 and causing the processor 101 to execute the program. The processor 101 operates the communication control unit 104, the input device 105, or the output device 106 according to the program to read and write data in the main storage unit 102 or the auxiliary storage unit 103. The data or database required for processing is stored in the main storage unit 102 or the auxiliary storage unit 103.

The server 10 is constituted by at least one computer. In a case where a plurality of computers is used, these computers are connected via a communication network such as the Internet or an intranet, whereby one logical the server 10 is constructed.

### [Operation of System]

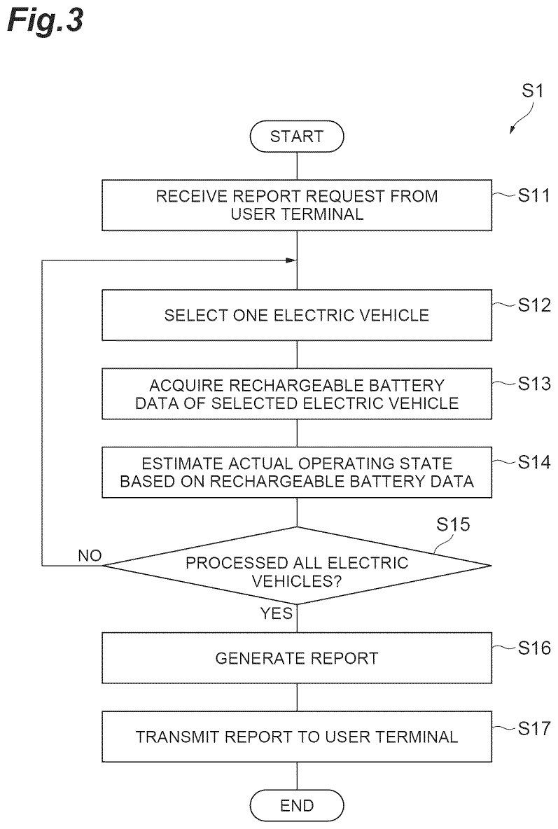

With reference to FIG. 3, an example of processing by the operation management system 1 (server 10) will be described, and an example of the operation management method according to the present embodiment will be described. FIG. 3 is a flowchart showing an example of the processing as a processing flow S1.

In step S11, the receiving unit 11 receives a report request from the user terminal 30. The report request is a data signal for requesting the server 10 to generate and provide the report. The user terminal 30 generates the report request based on a user operation and transmits the report request to the server 10. In one example, the report request includes at least one electric vehicle ID. For example, the report request may include the electric vehicle ID of at least one electric vehicle 2 located in a particular place such as a business office and a work-site. The report request may include the electric vehicle ID of at least one electric vehicle 2 at each of a plurality of locations. The report request may include a target period for estimating the actual operating state. In one example, the target period is set on a daily, weekly, monthly, or yearly basis.

In step S12, the acquisition unit 12 selects one electric vehicle 2 (one electric vehicle ID) based on the report request.

In step S13, the acquisition unit 12 acquires the rechargeable battery data of the selected electric vehicle 2. The acquisition unit 12 reads out the rechargeable battery data corresponding to the selected electric vehicle ID, from the database 20.

In step S14, the estimation unit 13 estimates the actual operating state of the selected electric vehicle 2, based on the rechargeable battery data. In one example, the estimation unit 13 calculates a moving average of the measured current for each of a plurality of intervals set along a time axis. Subsequently, the estimation unit 13 selects a set of intervals in which the moving average of the measured current is equal to or greater than a given threshold. This threshold may be a value for distinguishing whether or not the electric vehicle 2 is in an idling state, and may be set to 1 (A) or 0.05 (CA), for example. The unit “A” means the measured current value, and the unit “CA” means the C-rate. The estimation unit 13 then calculates the actual operating time on each day in the target period based on the number of the selected intervals, and calculates the actual operating rate based on the actual operating time and each business hour on each day. The actual operating rate is an example of the actual operating state of the electric vehicle 2. The estimation unit 13 obtains a ratio of the actual operation time to the business time as the actual operating rate. The business hour is a time width that are set as a time in which the electric vehicle 2 is to be operated. The business hour is set based on, for example, working hours of a work-site in which the electric vehicle 2 is arranged. It should be noted that an interval in which the moving average of the measured current is greater than or equal to a given threshold may also occur during a time outside the business hour.

Depending on a current sensor, an offset error due to temperature and a hysteresis error due to residual magnetism become large at a small current, which increases an error of the measurement value. By excluding the interval corresponding to the idling state in which the current is small, the error may be reduced or avoided, and the measurement value can be accurately calculated. The idling state refers to a state in which the electric vehicle 2 operates with no load. Examples of a device for grasping the operating rate of the electric vehicle include an integrated hour meter of a forklift. However, the integrated hour meter measures the operating time so as to include a time width of the idling state. Therefore, in one example, it is required to grasp the actual operating time excluding the time of the idling state.

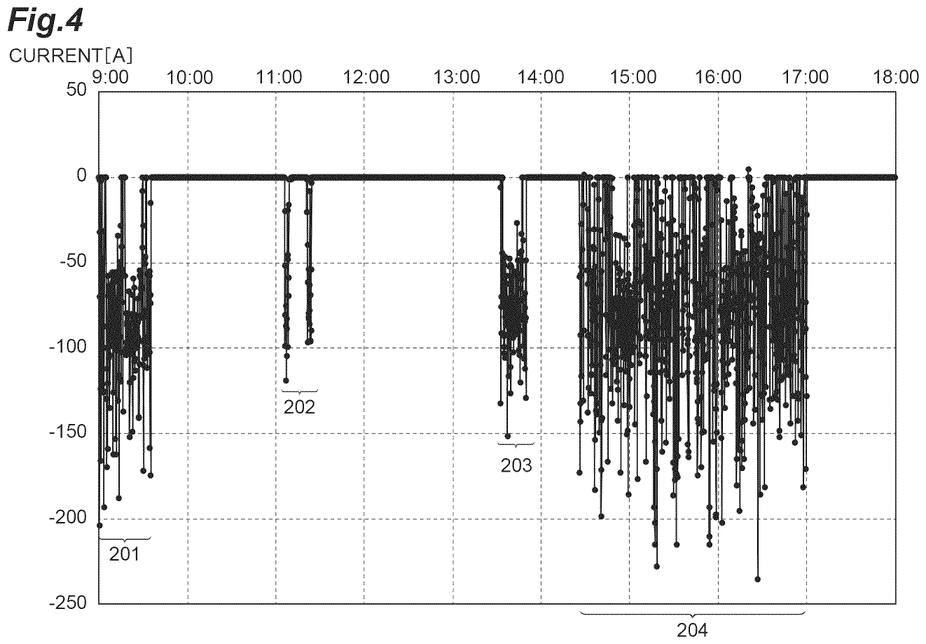

FIG. 4 shows an example calculation of the actual operating rate. FIG. 4 is a graph showing an example of a temporal change in the moving average of the measured current during a business hour (9:00 to 17:00) of a certain day. The horizontal axis represents time, and the vertical axis represents current (A). For example, when a time interval between records is 100 milliseconds, the estimation unit 13 sets the interval to 10 seconds, and calculates an average of 100 measured currents in the interval every 10 seconds. That is, the estimation unit 13 calculates the average of the measured current for each of a plurality of intervals each of which is 10 seconds long. In a case where the length of the interval is 10 seconds, the moving average is obtained for each of 8640 intervals corresponding to one day (24 hours). Subsequently, the estimation unit 13 selects a set of intervals in which the moving average is equal to or greater than a given threshold (e.g., 1 (A)). If the set of intervals consists of k intervals in a certain day, the estimation unit 13 calculates the actual operation time of the electric vehicle 2 as 10 (seconds)×k. In the example of FIG. 4, the k intervals are generally positioned in four time periods 201, 202, 203, 204. Assuming that k=1065 and the business hour of that day is 8 hours (28800 seconds) as described above, the estimation unit 13 calculates the actual operating rate of the electric vehicle 2 of the day as 10650/28800*100≈37 (%).

Returning to FIG. 3, as shown in step S15, the server 10 repeats the processing of steps S12 to S14 until all the electric vehicle 2 indicated by the report request are processed. In a case where the process is repeated, a next electric vehicle 2 is selected in step S12 and the actual operating state of that electric vehicle 2 is estimated by a series of processes of steps S13 and S14.

In step S16, the generation unit 14 generates the report indicating operation information based on the actual operating state of each electric vehicle 2. This report is electronic data that may be visualized. For example, the generation unit 14 may generate the report indicating a transition of the actual operating state of each electric vehicle 2 in the target period as the operation information. Alternatively, the generation unit 14 may generate the report indicating a statistic value of the actual operating state of each electric vehicle 2 as the operation information. For example, the generation unit 14 may calculate an average of the actual operating states of a plurality of electric vehicles 2 in a particular place such as a business office or a work-site, and generate the report indicating the average.

In step S17, the transmission unit 15 transmits the report to the user terminal 30. The user terminal 30 receives and displays the report. The user may grasp the actual operating state of each electric vehicle 2 by the report. Further, by the report, the user may determine the appropriate number of the electric vehicles 2 in a particular place such as a business office or a work-site, or may rearrange the electric vehicle 2 between places in order to achieve the appropriate number.

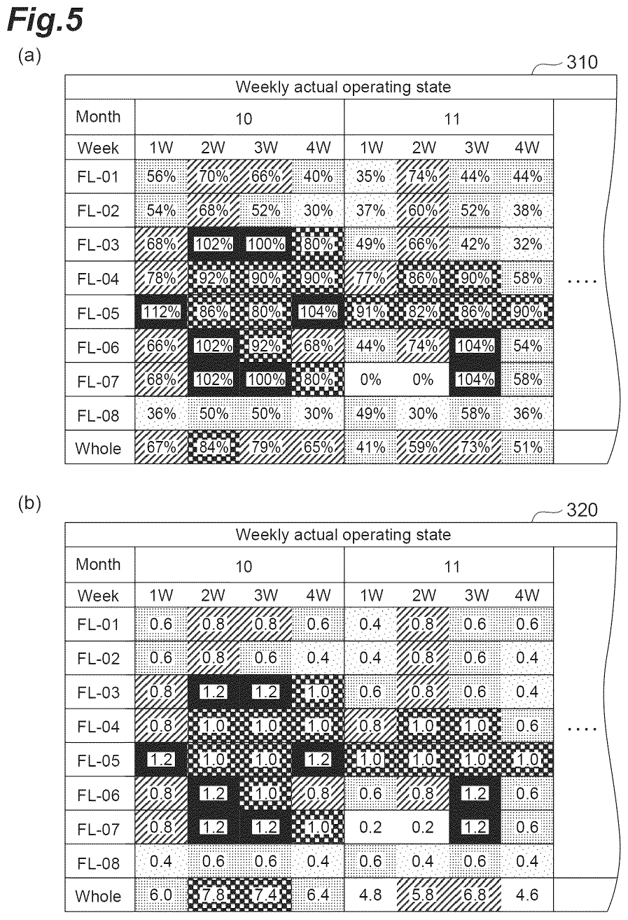

FIG. 5 is a diagram showing two examples of the report. Both of the examples (a) and (b) show a report indicating the actual operating state of eight electric vehicles 2 identified as FL-01 to FL-08 on a weekly basis. A report 310 in the example (a) represents a transition of the actual operating state by a time series heat map of the actual operating rate. The actual operating rate of the “Whole” row of the report 310 indicates an average of eight electric vehicles 2. A report 320 in the example (b) represents the actual operating state by the time series heat map of a rating index that is set based on the actual operating rate. The rating index is an example of the actual operating state of the electric vehicle 2. In this example, the generation unit 14 sets a relationship between the rating index and the actual operating rate as follows. An actual operating rate of 100% or more and a rating index of 1.2 indicate that the electric vehicle 2 operated for longer than the business hour. The rating index of the “Whole” row of the report 320 indicates the total of eight electric vehicles 2.
Rating index=0.2 (actual operating rate is 0% or more and less than 20%)
Rating index=0.4 (actual operating rate is 20% or more and less than 40%)
Rating index=0.6 (actual operating rate is 40% or more and less than 60%)
Rating index=0.8 (actual operating rate is 60% or more and less than 80%)
Rating index=1.0 (actual operating rate is 80% or more and less than 100%)
Rating index=1.2 (actual operating rate is 100% or more)

The generation unit 14 may generate at least one of the reports 310 and 320 or may generate both the reports 310 and 320. In any case, the user can take measures for making the number or arrangement of the electric vehicles more appropriate with reference to the report 310 or 320.

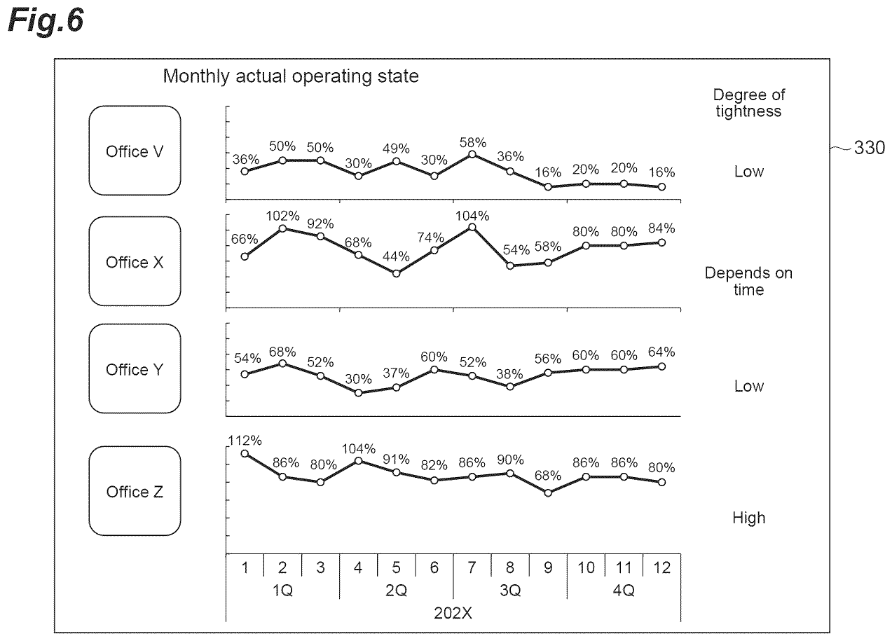

FIG. 6 is a diagram showing another example of report. A report 330 shown in this figure shows monthly averages of the actual operating state of the electric vehicles 2 in a certain year, at each of four business offices. The report 330 is an example report indicating the actual operating state in each of a plurality of places as the operation information. The report 330 represents the actual operating state by a line graph of the average of the actual operating rates. The report 330 further indicates a degree of tightness which is set based on the average of each month. The degree of tightness is an index representing whether or not the operation of the electric vehicle 2 is tight, and is also an example of the expression of the actual operating state. As there becomes less leeway in the operation of the electric vehicle 2, the degree of tightness increases. The report 330 shows that the degree of tightness is low throughout the year in offices V and Y, the degree of tightness is high depending on the time in an office X, and the degree of tightness is high throughout the year in an office Z. The user can take measures to make the number or arrangement of electric vehicles more appropriate with reference to the report 330. For example, the user may make adjustments such as transferring some electric vehicles 2 from the office V or Y to the office Z, or temporarily adding the electric vehicle 2 to the office X under a lease or rental contract at a particular time.

### [Program]

An operation management program for causing a computer or computer system to function as the operation management system 1 or the server 10 includes a program code for causing the computer or computer system to function as the receiving unit 11, the acquisition unit 12, the estimation unit 13, the generation unit 14, and the transmission unit 15. The operation management program may be provided after being non-temporarily recorded in a tangible recording medium such as a CD-ROM, a DVD-ROM, or a semiconductor memory. Alternatively, the operation management program may be provided as a data signal superimposed on a carrier through a communication network. The provided operation management program is stored in the auxiliary storage unit 103, for example. The processor 101 reads and executes the operation management program from the auxiliary storage unit 103 to implement each functional module described above.

### Effects

As described above, an operation management system according to an aspect of the present disclosure includes: an acquisition unit configured to acquire rechargeable battery data indicating a state of a rechargeable battery mounted on an electric vehicle; an estimation unit configured to estimate an actual operating state of the electric vehicle based on the rechargeable battery data; a generation unit configured to generate a report indicating operation information that is based on the actual operating state; and an output unit configured to output the report.

An operation management method according to an aspect of the present disclosure is executed by an operation management system including at least one processor. The operation management method includes: acquiring rechargeable battery data indicating a state of a rechargeable battery mounted on an electric vehicle; estimating an actual operating state of the electric vehicle based on the rechargeable battery data; generating a report indicating operation information that is based on the actual operating state; and outputting the report.

An operation management program according to an aspect of the present disclosure causes a computer to execute: acquiring rechargeable battery data indicating a state of a rechargeable battery mounted on an electric vehicle; estimating an actual operating state of the electric vehicle based on the rechargeable battery data; generating a report indicating operation information that is based on the actual operating state; and outputting the report.

In such aspects, the actual operating state of the electric vehicle is estimated from rechargeable battery data related to the rechargeable battery mounted on the electric vehicle. Then, the report indicating the operation information based on the actual operating state is generated. This report makes it possible to convey information about actual operation of the electric vehicle to a user. In one example, the user can take measures to make the number of electric vehicles more appropriate with reference to the report.

In the operation management system according to another aspect, the estimation unit may be configured to estimate, as the actual operating state, an actual operating rate that is a ratio of an actual operating time of the electric vehicle to a business hour set as a time for operating the electric vehicle. By using the ratio of the actual operating time to the business hour, it is possible to provide a user with operation information considering the actual use situation of the electric vehicle.

In an operation management system according to another aspect, the state of the rechargeable battery may include at least a measured current of the rechargeable battery. The estimation unit may be configured to: calculate a moving average of the measured current for each of a plurality of intervals set along a time axis, based on the rechargeable battery data; use a threshold for distinguishing whether the electric vehicle is in an idling state to select a set of intervals in which the moving average of the measured current is equal to or greater than the threshold, from the plurality of intervals; calculate an actual operating time of the electric vehicle based on a number of intervals constituting the set of intervals and a length of each interval; and estimate the actual operating state based on the actual operating time. Depending on a current sensor, an offset error due to temperature and a hysteresis error due to residual magnetism become large at a small current, which increases an error of a measurement value. By excluding data in which the moving average of the measured current is small, the error can be reduced or avoided, and the actual operating time can be accurately calculated.

In the operation management system according to another aspect, the generation unit may be configured to generate the report representing a transition of the actual operating state in a given target period by a time series heat map. The time series heat map makes it possible to present a transition of the actual operating state of the electric vehicle to the user in an easy-to-understand manner.

In the operation management system according to another aspect, the acquisition unit may be configured to acquire the rechargeable battery data for at least one electric vehicle in each of a plurality of locations, the estimation unit may be configured to estimate the actual operating state for each electric vehicle, and the generation unit may be configured to generate the report indicating the actual operating state at each of the plurality of locations as the operation information. In this case, information on the actual operation of the electric vehicle can be conveyed to the user such that the user can grasp the situation in each of the plurality of places at a glance.

In an operation management system according to another aspect, the electric vehicle may be a material handling vehicle. In this case, information about the actual operation of the material handling vehicle can be conveyed to the user.

### Modifications

The present invention has been described above in detail based on the embodiments. However, the present invention is not limited to the embodiments described above. The present invention may be modified in various ways without departing from the scope thereof.

The BMU 3 may calculate the moving average of the measured current, and transmit the rechargeable battery data indicating the moving average to the database 20. Alternatively, the BMU 3 may transmit, to the database 20, only data of intervals in which the moving average of the measured current is greater than or equal to a given threshold. As in the above embodiments, the threshold may be a value for distinguishing whether the electric vehicle 2 is in an idling state. In these cases, data traffic between the BMU 3 and the database 20 may be reduced, and the processing load in the server 10 can be reduced.

The processing procedure of the method executed by at least one processor is not limited to the example in the above embodiment. For example, some of the above-described steps (processes) may be omitted, or the steps may be executed in a different order. Further, any two or more steps among the above-described steps may be combined, or part of the steps may be modified or deleted. Alternatively, other steps may be executed in addition to the above-described steps.

In a comparison of the magnitude relationship between two numerical values in the present disclosure, either of two criteria of “equal to or greater than” and “greater than” may be used, and either of two criteria of “equal to or less than” and “less than” may be used. Such selection of the reference does not change the technical significance of the process of comparing the magnitude relationship between the two numerical values.

In the present disclosure, “at least one processor executes a first process, executes a second process, . . . , executes an n-th process” or an expression corresponding thereto indicates a concept including a case where an execution subject (i.e., a processor) of n processes from the first process to the n-th process changes in the middle. That is, this expression indicates a concept including both a case where all the n processes are executed by the same processor and a case where the processor changes in an arbitrary policy among the n processes.

### REFERENCE SIGNS LIST

1 . . . operation management system; 2 . . . electric vehicle; 3 . . . BMU; 10 . . . server; 11 . . . receiving unit; 12 . . . acquisition unit; 13 . . . estimation unit; 14 . . . generation unit; 15 . . . transmission unit; 20 . . . database; 30 . . . user terminal; 310, 320, 330 . . . report.

1. An operation management system comprising:
an acquisition unit configured to acquire rechargeable battery data indicating a state of a rechargeable battery mounted on an electric vehicle;
an estimation unit configured to estimate an actual operating state of the electric vehicle based on the rechargeable battery data;
a generation unit configured to generate a report indicating operation information that is based on the actual operating state; and
an output unit configured to output the report.

2. The operation management system according to claim 1, wherein the estimation unit is configured to estimate, as the actual operating state, an actual operating rate that is a ratio of an actual operating time of the electric vehicle to a business hour set as a time for operating the electric vehicle.

3. The operation management system according to claim 1, wherein
the state of the rechargeable battery includes at least a measured current of the rechargeable battery, and
the estimation unit is configured to:
calculate a moving average of the measured current for each of a plurality of intervals set along a time axis, based on the rechargeable battery data;
use a threshold for distinguishing whether the electric vehicle is in an idling state to select a set of intervals in which the moving average of the measured current is equal to or greater than the threshold, from the plurality of intervals;
calculate an actual operating time of the electric vehicle based on a number of intervals constituting the set of intervals and a length of each interval; and
estimate the actual operating state based on the actual operating time.

4. The operation management system according to claim 1, wherein the generation unit is configured to generate the report representing a transition of the actual operating state in a given target period by a time series heat map.

5. The operation management system according to claim 1, wherein
the acquisition unit is configured to acquire the rechargeable battery data for at least one electric vehicle in each of a plurality of locations,
the estimation unit is configured to estimate the actual operating state for each electric vehicle, and
the generation unit is configured to generate the report indicating the actual operating state at each of the plurality of locations as the operation information.

6. The operation management system according to claim 1, wherein the electric vehicle is a material handling vehicle.

7. An operation management method executed by an operation management system comprising at least one processor, the method comprising:
acquiring rechargeable battery data indicating a state of a rechargeable battery mounted on an electric vehicle;
estimating an actual operating state of the electric vehicle based on the rechargeable battery data;
generating a report indicating operation information that is based on the actual operating state; and
outputting the report.

8. A non-transitory computer-readable storage medium storing an operation management program causing a computer to execute:
acquiring rechargeable battery data indicating a state of a rechargeable battery mounted on an electric vehicle;
estimating an actual operating state of the electric vehicle based on the rechargeable battery data;
generating a report indicating operation information that is based on the actual operating state; and
outputting the report.
